(19) United States
(12) Patent Application Publication
(10) Pub. No.: US 2024/0107947 A1
(43) Pub. Date: Apr. 4, 2024

(54) ROBOTIC FRUIT HARVESTING SYSTEM

(71) Applicant: AppHarvest Technology, Inc., Morehead, KY (US)

(72) Inventors: Matthew Borgatti, Morehead, KY (US); Ryan R. Knopf, Morehead, KY (US); Ryan Wasserman, Morehead, KY (US); Joshua Aaron Lessing, Morehead, KY (US); Jason A. Chrisos, Morehead, KY (US); Michele Pratusevich, Morehead, KY (US); Wesley Bird, Morehead, KY (US)

(21) Appl. No.: 18/553,722

(22) PCT Filed: Apr. 1, 2022
(86) PCT No.: PCT/US2022/023033

§ 371 Date: Oct. 2, 2023

Related U.S. Application Data
(60) Provisional application No. 63/170,232, filed on Apr. 2, 2021.
(60) Provisional application No. 63/265,400, filed on Dec. 14, 2021.

(51) Int. Cl. A01D 46/30

(52) U.S. Cl. CPC A01D 46/30

(57) ABSTRACT

A collection tool comprises a drive chassis, a harvester module disposed on the drive chassis, the harvester module including a vision system configured to identify target objects, and a robotic arm including a grasper configured to collect the target objects, and a subsystem including an articulating semi-rigid catch member, the semi-rigid catch member configured to transition into a retracted state while the drive chassis is in motion and to transition into an extended state while the drive chassis is stationary and the robotic arm is in a process of collecting the target objects.

### CROSS-REFERENCE TO RELATED APPLICATIONS

This application claims priority under 35 U.S.C. § 119(e) to U.S. Provisional Patent Application Ser. No. 63/170,232, titled “DUAL ARM ROBOTIC FRUIT HARVESTING SYSTEM,” filed Apr. 2, 2021, and to U.S. Provisional Patent Application Ser. No. 63/265,400, titled “DUAL ARM ROBOTIC FRUIT HARVESTING SYSTEM,” filed Dec. 14, 2021. The contents of each of these applications are incorporated herein in their entireties for all purposes.

### GOVERNMENT SUPPORT STATEMENT

This invention was made with government support under Contract No. 1951077 awarded by the National Science Foundation. The government has certain rights in the invention.

### BACKGROUND

Agricultural technology is a sector of significant commercial interest. Examples of some emerging agricultural technologies pertain to automated farming tools for crop care and irrigation. Automation of harvesting operations poses significant challenges. Aspects and embodiments disclosed herein relate to methods for harvesting agricultural fruits and vegetables using a semi-autonomous mobile robot.

### SUMMARY

In accordance with one aspect, there is provided a collection tool. The collection tool comprises a drive chassis, a harvester module disposed on the drive chassis, the harvester module including a vision system configured to identify target objects, and a robotic arm including a grasper configured to collect the target objects, and a subsystem including an articulating semi-rigid catch member, the semi-rigid catch member configured to transition into a retracted state while the drive chassis is in motion and to transition into an extended state while the drive chassis is stationary and the robotic arm is in a process of collecting the target objects.

In some embodiments, the semi-rigid catch member comprises a plurality of linkages.

In some embodiments, the collection tool further comprises a linear actuator configured to articulate the plurality of linkages between the retracted and extended states.

In some embodiments, the semi-rigid catch member comprises a plurality of pivoting panels.

In some embodiments, the collection tool further comprises a linear actuator configured to articulate the plurality of pivoting panels between the retracted and extended states.

In some embodiments, the semi-rigid catch member comprises a linear retracting and extending front member and a linear actuator configured to retract and extend the front member.

In some embodiments, the linear actuator includes one or more pneumatic cylinders, linear motor and rail systems, rotary motors with ball or lead screw mechanisms, or hydraulic pistons/diaphragms.

In some embodiments, the collection tool further comprises a target surface connected to the semi-rigid catch member and formed of a compliant material configured to receive collected target objects and to direct the target objects through an outlet.

In some embodiments, the semi-rigid catch member comprises a dynamically adjustable and flexible hoop.

In some embodiments, the hoop includes a flexible hinged roller chain.

In some embodiments, the hoop includes a flexible bar element.

In some embodiments, the collection tool further comprises a double-acting linear actuator configured to retract and extend the hoop.

In some embodiments, the double-acting linear actuator is a pneumatic cylinder having one end affixed to a side of the collection tool and having a single rotational degree of freedom.

In some embodiments, the pneumatic cylinder includes a second end affixed to a side of the hoop and having three degrees of freedom including translation in two directions as well as rotation about the clevis pivot.

In some embodiments, a body of the pneumatic cylinder is configured to move in an arc motion while extending and retracting.

In some embodiments, the hoop has a first area in a retracted position and a second area greater than the first area in an extended position.

In some embodiments, a front portion of the hoop is configured to conform to an obstacle impacted by the hoop.

In some embodiments, the collection tool further comprises a target surface formed of a compliant material connected to the hoop and configured to receive collected target objects and to direct the target objects through an outlet.

In some embodiments, the target surface is releasably connected to the hoop.

In some embodiments, the target surface is tapered toward the outlet.

In some embodiments, the collection tool further comprises a sensor coupled to a base of the semi-rigid catch member and configured to sense objects passing through the subsystem.

In some embodiments, the collection tool further comprises a conveyor disposed along a side of the harvester module downstream of the catch member and configured to transport objects into a collection bin.

In some embodiments, the conveyor is inclined upward in a direction toward the collection bin.

In some embodiments, the conveyor includes a cleated conveyor belt.

In accordance with another aspect, there is provided a collection tool. The collection tool comprises a drive chassis, a harvester module disposed on the drive chassis, the harvester module including a vision system configured to identify target objects, and a robotic arm including a grasper configured to collect the target objects, and a comprehensive landing zone for target objects dropped from the grasper including a flexible fabric structure mounted to static points on the collection tool.

In some embodiments, the flexible fabric structure includes a mixture of compliant fabrics or netting combined with reinforcements formed of less flexible fabric.

In some embodiments, the less flexible fabric includes ripstop nylon.

In some embodiments, the flexible fabric structure is mounted to the static points on the collection tool with quick release/attachment fasteners.

In some embodiments, the collection tool further comprises a collection bin.

In some embodiments, the collection tool further comprises a conveyor disposed along a side of the collection tool configured to transport objects collected by the robotic arm into the collection bin.

In some embodiments, the conveyor is inclined.

In some embodiments, the conveyor includes a cleated conveyor belt.

In accordance with another aspect, there is provided a system for collecting agricultural products from a crop row. The system comprises a collection tool including a drive chassis, a harvester module disposed on the drive chassis, the harvester module including a vision system configured to identify target objects, and a robotic arm including a grasper configured to collect the target objects, and a catch system including a trough-shaped catch zone extending substantially along a full length of the crop row formed of a compliant material and including an outlet, and a conveyance zone disposed below the outlet of the catch zone and including a conveyor configured to transport target objects to a collection bin.

### BRIEF DESCRIPTION OF THE DRAWINGS

Embodiments of this disclosure will now be described, by way of non-limiting example, with reference to the accompanying drawings.

FIG. 1 illustrates an embodiment of a dual arm robotic fruit harvesting system;

FIG. 2 illustrates an embodiment of a fruit catch subsystem of a robotic fruit harvesting system;

FIG. 3 illustrates an example of fruit being dropped into and captured by the fruit catch subsystem and directed into a catch chute into a fruit collection or conveyance subsystem;

FIG. 4 illustrates an embodiment of a mechanism for displacing a fruit catch subsystem of a robotic fruit harvesting system;

FIG. 5A illustrates dynamic positioning of a fruit catch subsystem of a robotic fruit harvesting system using a telescoping link on the leading edge of the catch subsystem surface;

FIG. 5B illustrates dynamic positioning of a fruit catch subsystem of a robotic fruit harvesting system using flaps on the leading edge of the catch subsystem surface;

FIG. 6 illustrates an embodiment of a single armed robotic fruit harvesting system;

FIG. 7 illustrates an embodiment of a robotic fruit harvesting system including a fruit inspection sensor;

FIG. 8 illustrates a portion of a fruit collection sub-system including articulating linkages;

FIG. 9 illustrates a portion of a fruit collection sub-system including retractable and expandable interleavable panels;

FIG. 10 illustrates a portion of a fruit collection sub-system including an extending belt;

FIG. 11 illustrates a portion of a fruit collection sub-system including a roller chain hoop;

FIG. 12 illustrates a portion of a fruit collection sub-system including a flexible hoop;

FIG. 13 illustrates a portion of a fruit collection sub-system including a flexible fabric structure and conveyor belt;

FIG. 14 illustrates a portion of a fruit collection sub-system including offboard fruit collection and conveyance under gutter/crop;

FIGS. 15A and 15B illustrate a harvesting module for a robotic fruit harvesting system including a vision system that is decoupled from a manipulator arm;

FIGS. 16A and 16B illustrate a picking flow diagram for embodiments of robotic fruit harvesting systems disclosed herein;

FIGS. 17A and 17B illustrate another picking flow diagram for embodiments of robotic fruit harvesting systems disclosed herein;

FIG. 18 illustrates another picking flow diagram for embodiments of robotic fruit harvesting systems disclosed herein;

FIG. 19 illustrates another picking flow diagram for embodiments of robotic fruit harvesting systems disclosed herein;

FIG. 20 illustrates another picking flow diagram for embodiments of robotic fruit harvesting systems disclosed herein;

FIG. 21 illustrates another picking flow diagram for embodiments of robotic fruit harvesting systems disclosed herein;

FIG. 22 illustrates another picking flow diagram for embodiments of robotic fruit harvesting systems disclosed herein;

FIG. 23 illustrates another embodiment of a dual arm robotic fruit harvesting system;

FIG. 24A illustrates another embodiment of a dual arm robotic fruit harvesting system; and

FIG. 24B illustrates another embodiment of a dual arm robotic fruit harvesting system.

### DETAILED DESCRIPTION OF CERTAIN EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

Aspects and embodiments disclosed herein combine a fruit collection system along with two harvesting modules capable of independent picking and vision operations to achieve a significant improvement in performance.

Some embodiments of automated robotic mechanisms for collecting harvested fruits to a central bin or collection point utilize an articulated tray which is actively moved to maintain configurable distance away from an actively picking robotic arm and fruit grasping tool. This tray provides a place for the arm and grasper to explicitly place the currently grasped fruit before continuing work. While those embodiments are preferred for fruits which should be carefully placed to avoid damage or bruising (for example, strawberries and larger tomatoes) in some embodiments it is not optimally time inefficient to fully decelerate and pause to place individual harvested items with enough mechanical robustness to withstand being dropped short distances. For that, new methods are preferred which are contemplated in this disclosure.

In aspects and embodiments of systems and methods disclosed herein, fruits may be collected by a catch positioned at the base of a robotic manipulator and grasper. This catch does not need to be actuated to articulate up and down with the manipulator. Instead, by virtue of its contoured surfaces, wide area of acceptance through a funnel like shape, and single outlet point, it may collect fruits which are dropped from a wide range of positions by the manipulator to an outbound fruit conveyance system. In some embodiments, compliant and/or dynamic mechanisms may be used to increase the coverage of the fruit collector, as well as conform to the variable environment. That outbound conveyance system may be a conveyor belt, bin belt, sloped chute, articulated bin, or other device which accomplishes the purpose of conveying the fruits to one end of the system for easy removal and aggregation into outbound delivery of fruits.

Aspects and embodiments of the disclosed fruit collection system allows for further performance improvements to the path planning of the manipulator arm, where one can leverage dynamic motions while depositing fruits to the fruit collector. The implementation of an independent motion axis intended for target acquisition and route planning decreases the system downtime by keeping the robotic arm consistently performing picking actions. Several autonomy methods are described to achieve this operational efficiency leveraging a parallelized target acquisition and picking strategy.

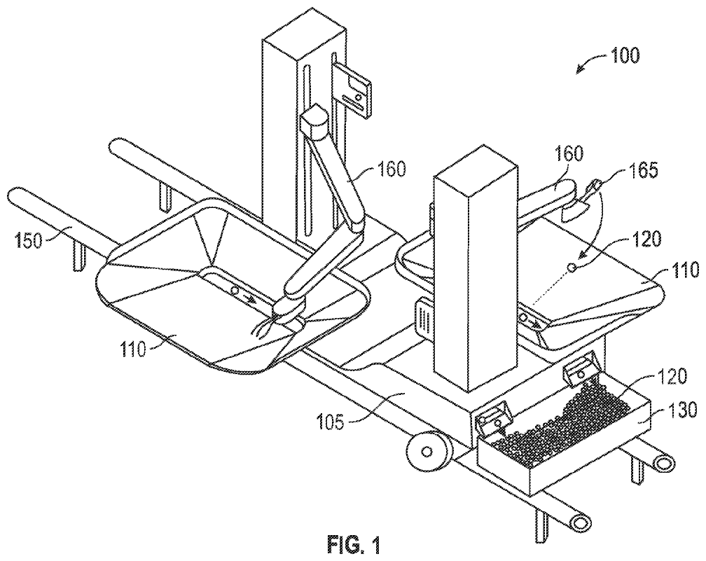

These harvest module and fruit collection system improvements are, in some embodiments, further leveraged by using two harvest modules per system. The two harvest modules may have alternate mounting methods, and in some embodiments each arm is oriented to allow picking on opposite sides of a crop row. This orientation allows the system to achieve a multiplication factor of performance and decreases the time to harvest an individual crop row. One embodiment of a dual arm robotic fruit harvesting system is illustrated in FIG. 1, indicated generally at 100. The system includes a drive chassis 105 configured to move in path, for example, between rows of plants in a greenhouse, optionally along a set of tracks 150. Aspects and embodiments of arm robotic fruit harvesting systems disclosed herein may include one or more harvester modules mounted on the drive chassis 105 and including one or more robotic arms or manipulators 160 terminating in grippers 165 such as disclosed in any one or more of PCT Patent Application Serial Nos. PCT/US2019/039254, PCT/US2020/018392, or PCT/US2021/020476, the subject matter of which is incorporated herein by reference.

### Fruit Collection System

The wide area of acceptance (also referred to herein as the catch) of embodiments of the fruit collection system achieves three purposes to facilitate a high performing automated harvesting system. Firstly, it allows the expedited release of fruits during a dynamic movement due to the geometry and surfaces employed. Secondly, it increases the coverage of fruits that otherwise could have dropped down to the floor, rendering them no longer edible or salable, in cases where the grasper disturbs an item that is not its target or manages only a marginal grasp on its current target. The grasper may be opened to release a collected target object, for example, a fruit at any point where the grasper is generally accelerating and moving toward the center axis of the harvesting system, effectively throwing the fruit in a generally parabolic trajectory toward the catch. There is a great deal of variability in the landing location of fruits released this way, but a sufficiently broad catch can accommodate most or all of them. By releasing the target object while still in motion, the manipulator and grasper need not fully decelerate and pause to open for placement, dramatically increasing the speed with which successive targets may be acquired and increasing the productivity of the harvesting system. Last, through dynamically repositioning the leading edge of the lower catch subsystem, increased coverage is enabled in a highly dynamic environment while simultaneously reducing or eliminating potential for crop damage. These three performance improvement aspects are enabled through the proper geometry, sizing, materials, dynamic placement, and several other factors which will be further described below. This method permits the manipulator and grasper to release fruits from a wide range of positions without concern about whether they will be collected by the catch.

### Surfaces & Sizing

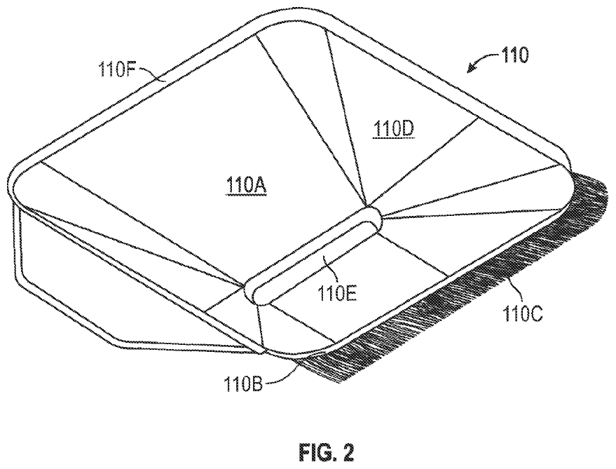

There are several surfaces involved in the implementation of a successful lower fruit catch design. An embodiment of a lower fruit catch is illustrated in FIG. 2, indicated generally at 110. Surface 117A of the fruit catch is the intended semi-compliant surface upon which fruits released by the manipulator arm grasper are caught in a safe manner. Surface 117B is the leading edge upon which the distance covered underneath the crop environment is maximized to catch any accidentally dropped fruits or fruits falling due to other factors. This leading edge is intended to be dynamically positionable in accordance with embodiments which will be discussed below. In some embodiments, this leading edge may have an additional compliant element 110C such as a strip-brush or flexible carbon fiber rod that enables consistent engagement coverage with the environment while not damaging the crop. Other surfaces than the front edge may employ these compliant material methodologies as well. Any of these compliant members may return to their un-deformed state after any environmental loads are induced as to retain proper function of the collector. Surface(s) 110D are the surfaces that serve as a guide to funnel the fruits towards the pass-through chute 110E or zone to transfer out through the chosen fruit conveyance method. Surface(s) 110F are elevated/vertical surfaces that serve to form a “rim” around the rest of the lower catch geometry. This rim geometry is intended to prevent fruits from inadvertently rolling outside of the envelope of the catch volume due to the parabolic and variable motion upon drop-off. In some embodiments, a minimum angle of 20-25 degrees is maintained (as measured from the top plane) for surfaces 117A, 117B, and 110D to minimize the chance for fruits to “pool” or get stuck prior to entering the chute or pass-through 110E to the conveyance subsystem. This angle of 20-25 degrees is beneficial for minimizing fruit pooling as well as increasing the speed at which fruits enter the conveyance subsystem, minimizing chances of fruit exiting the lower catch and falling to the ground, and serve to reduce the impact loading on the fruit to reduce the potential for damage. In scenarios where the crop environment is highly constraining to the physical design of the lower catch angles, a lower angle of the leading edge may be used when aided by a physical agitator that entices proper fruit funneling through the catch chute. There are many methods for achieving proper agitation. A reciprocating cam mechanism under the leading surface 117B can provide pushing motion on the compliant surface to push the fruits through, pneumatics/etc. can induce a vibration into the structure, etc.

The catch itself may be constructed from any generally available material and still serve as an effective collection system, but it is advantageous, when seeking to minimize damage to fruits, to construct it from compliant materials or structures. These may include but aren't limited to: foam lined panels, supported fabric, flexible panel, spring loaded panels or mechanisms, or inflated structures which are pressurized with a working fluid like air or water. Given these proposed material and geometry implementations, this design provides for the safe dropping of fruits into the lower catch from varied heights. The recommended dropping range to ensure fruit safety is between 0 and 1.5 meters. This maximum dropped height will vary between fruit and vegetable types/varietals.

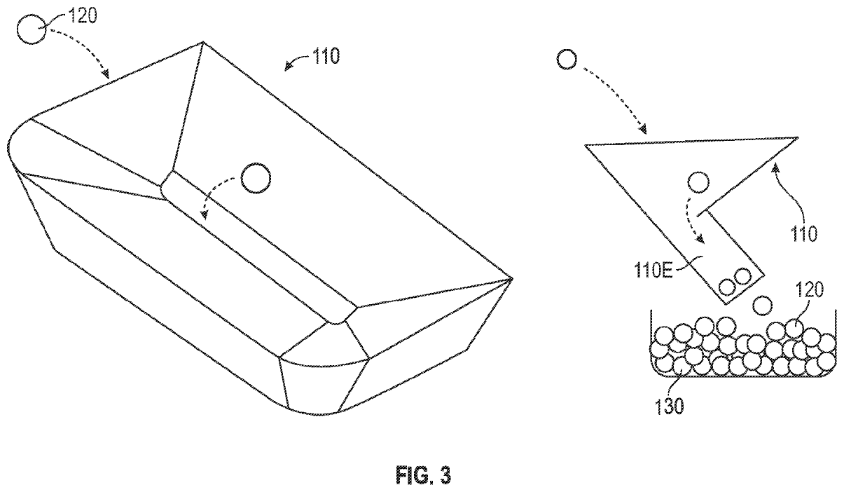

FIG. 3 illustrates an example of fruit 120 being dropped into and captured by the fruit catch subsystem and directed into a catch chute into a fruit collection or conveyance subsystem 130.

### Dynamic Positioning Methods

A feature that facilitates successful implementation of the lower fruit catch subsystem is the ability to dynamically adjust the drop coverage zone through repositioning of subsystem or portions of the subsystem. This feature reduces or eliminates chances that the robot interferes with and damages the crop environment, as well as optimizes the drop coverage zone to provide better performance. There are many potential obstacles in the crop environment that inhibit the ability for a static wide surface of the robot to successfully operate while moving up and down the rows. These obstacles may include but are not limited to: vine bundles, low hanging vines, crop gutter & hanging structures, vertical facility structural beams, and metal stands to hold the crop gutters in the air.

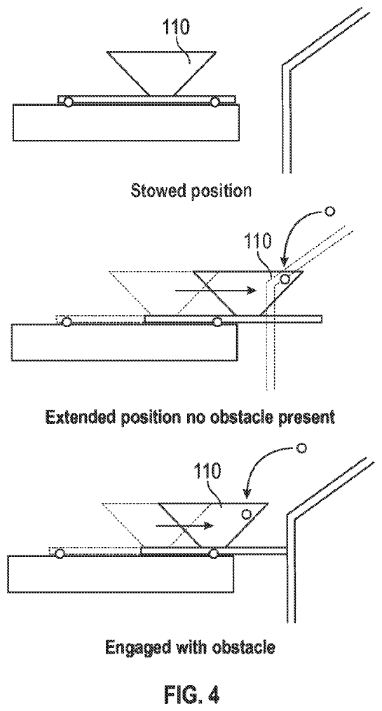

In some embodiments, the leading edge of the lower catch must be capable of dynamically retracting and deploying by ˜10 inches. This dynamic stroke range can be accomplished by several different means of actuation. One method to achieve this is through the linear retraction and extension of the entire lower catch subsystem. This method is illustrated in FIG. 4. This motion can be achieved through pneumatics, motors, springs, or other means. For the use case where the lower catch outputs fruits to a central bin, this forward and backward motion can also serve as a means for re-distributing fruit within the bin as they begin piling into the bin.

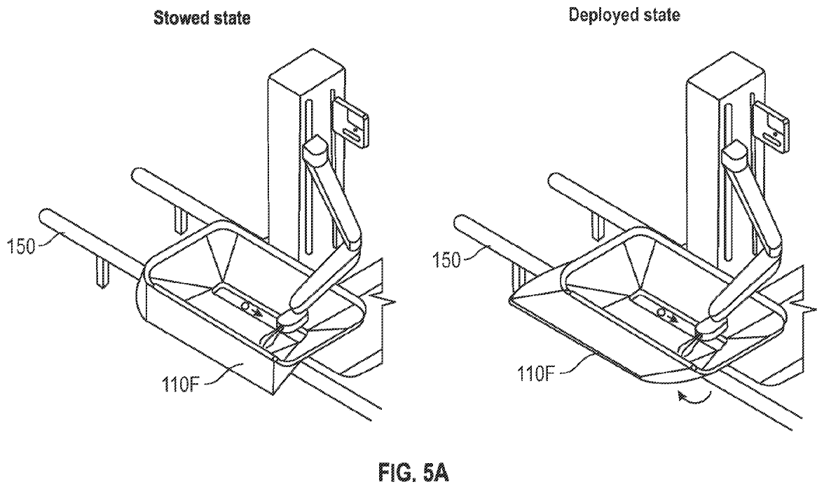

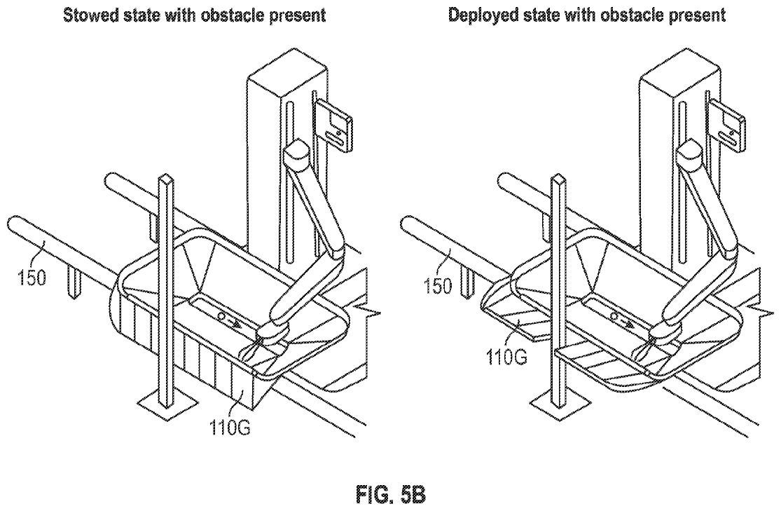

Another embodiment of achieving dynamic positioning is using a telescoping link 110F on the leading edge of the catch surface as illustrated in FIG. 5A. The compliance of the surface on this edge can be maintained through different methods such as a clock-spring that allows additional fabric to be deployed during extension while maintaining the proper tension for fruit catch and funneling. The leading edge of this telescoping surface may be semi-compliant or employ strip brushes/etc. to allow the partial deformation around an obstruction in the crop environment such as a vertical metal stanchion. This conformance would allow for an increased catch zone under the crop area when the system is in front of this obstruction.

Yet another embodiment for dynamic positioning of the leading catch edge is through the rotational deployment of a “flap” 110G as illustrated in FIG. 5B, where the flap deploys from, for example, the “6-oclock position” outwards underneath the crop environment. This leading edge could also involve several independent flaps that are mounted to the larger rotating structure through torsion springs, allowing only a specific sub-section of the deploying surface to remain “stowed” when pressing against an obstacle in the environment. This is another example of how to optimize drop coverage when the system is operating in front of an obstruction.

There are several methods upon which the system can decide when to deploy and retract these different embodiments of a dynamically positioned lower catch surface. One method is to perform a retraction movement prior to a movement of the robot along the rails 150, deploying once the new rail position has been secured. This method ensures minimal crop interference/damage due to the structure being retracted prior to any movement along the crop row. A passive approach could be taken where springs/pneumatics apply the correct amount of resistance to keep the lower catch subsystem deployed when possible but retracting out of the way when enough force is applied by an obstruction in the row. This movement could be induced through a lead-in edge that allows the easier transfer of forces. There are other actively sensed control inputs to the actuation that may be utilized in other embodiments, for example, a mechanical switch triggering a lead-in edge contacting the environment, the use of camera-vison, proximity sensors, etc.

### Outbound Conveyance & Sensing Modality

The lower fruit catch itself 110 generally employs sloped surfaces forming a “funnel like” shape to encompass a broad area while still collecting fruits to a single outlet point 110E. This outlet point 110E may feed the fruit to a method of conveyance to a central collection and aggregation area 130 on the system. However, passing all fruits through a single outlet of controlled shape also enables many different methods of object detection to be employed which may automatically detect fruits as they pass through the catch to the conveyor. Sensors used to perform that detection may include but aren't limited to: acoustic impact sensors, mechanism or paddles which activate a limit switch, weight sensors, optical proximity or break beam style sensors, monochromatic or color image sensors, ultrasonic sensors, force sensitive fabrics, and others. The passage of fruits through a corridor of known shape and geometry facilitates precise sensor characterization and consistent sensing conditions, for exceptionally high accuracy of detection—particularly for optical and acoustic sensing methods.

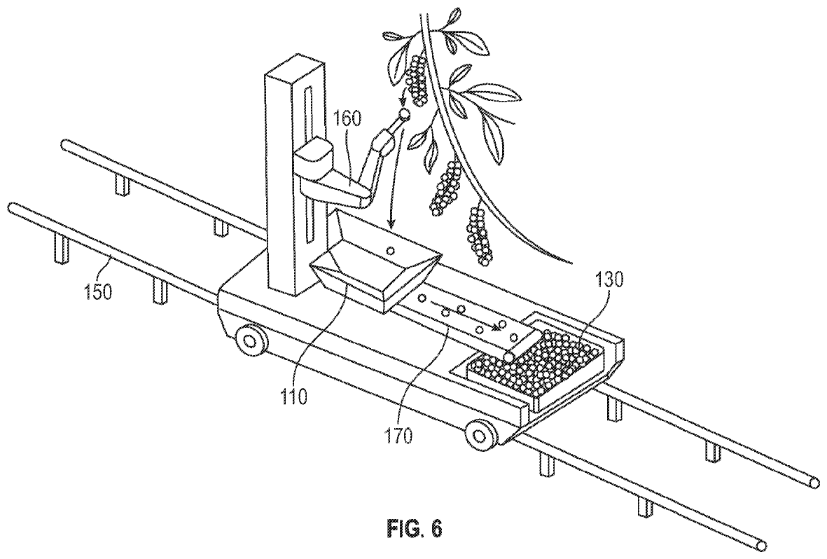

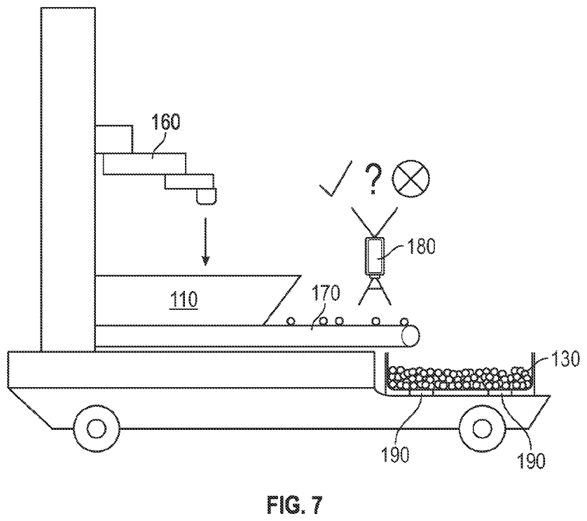

In one embodiment of a robotic fruit harvesting system as disclosed herein and illustrated in FIG. 6, a single arm 160 is employed which dynamically releases fruits into a single fruit catch 110 below it. That catch 110 has a single outlet which relays harvested fruits to a method of conveyance, for example, a conveyor belt 170. That conveyor belt 170 then conveys the fruits to a central point of collection and aggregation 130 at one end of the harvesting system. It should be appreciated that systems and methods which accomplish this style of central collection and aggregation have the advantage that they can be used to conveniently measure key attributes of the harvested fruits. As illustrated in FIG. 7, for example, a camera 180 may be positioned above the outlet of the harvested fruit conveyor 170 which may make quality determinations based upon algorithmic assessments of fruit damage, color or ripeness, size, or disease. The camera 180 can also be used for counting or estimating the accumulated amount of product harvested categorized by certain properties of the fruit. Rejected fruits may then be removed from the conveyor 170 to a separate cull collection point prior to reaching the final outbound collection tray 130.

Aggregation of all fruits to a central location 130 also provides a convenient location for monitoring the accumulated weight of harvested fruits. In some embodiments, for example, as illustrated in FIG. 7 load cells 190 under the final collection tray may continuously monitor the total mass of fruits harvested thus far. In conjunction with the count of fruits accumulated this can be used to estimate other properties of interest for the fruit, like the average weight or standard deviation in weight. These properties are of particular importance to farm operators and growers because they are frequently used in the process of forecasting production quantities and yields.

### Additional Fruit Collection Embodiments

Various alternative fruit collection subsystems for use with robotic fruit harvesting systems as disclosed herein may enhance the ability to robotically harvest crops by maximizing throughput and minimizing fruit damage by allowing the robot to drop fruits while moving to the next target picking location. In at least some aspects, a performance throughput level is achievable wherein at least about 90% of items that would otherwise be dropped are recovered. One alternative embodiment involves the use of a rigid hoop/bin that deploys and retracts as necessary on robot movement to allow for additional coverage below the plants and gutter to capture dropped pick attempts by the robotic arm.

This hoop also contains the primary sensing aperture for counting fruits. Another alternative embodiment involves the use of a more flexible hoop structure that also extends/retracts with robot movement below the plants and gutter but is more robust to obstacles in and around the plant and gutter system. A third alternative embodiment involves combining either of the aforementioned collection hoops with a rear flexible netting/fabric system attached to points onboard the robotic system. The upper/rear panels collect intentional picks when the robot arm drops fruit parabolically to these surfaces and directs them in a funneling method down to a sensing chute at the base of the lower/front hoop and ultimately onto a conveyor system. Another alternative embodiment involves taking fruits passing through the sensing aperture in the forward/lower hoop structure and conveying them to the end of the robot where they are dropped into a storage bin. This conveyor is angled with a cleated belt to maximize use of vertical space along the side of the robot and allowing the collection system to be as low as possible to minimize interference with the plants, gutter, or the picking arm. The conveyor allows for fruit to be carried upwards from the sensing aperture and dropped downward into the collection bin which is mounted on one end of the system in a location convenient to human interaction.

### First Alternative Fruit Collection Subsystem

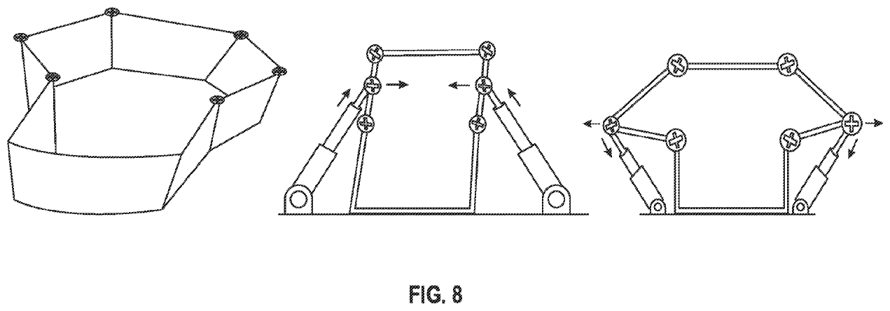

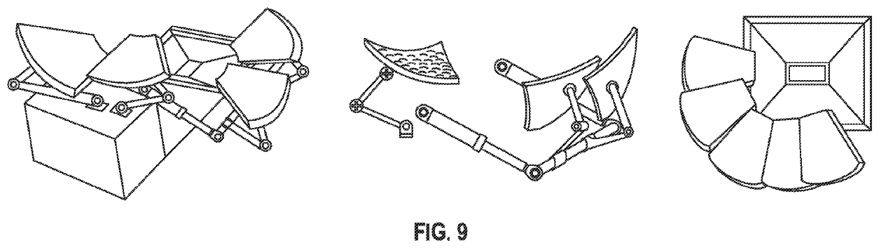

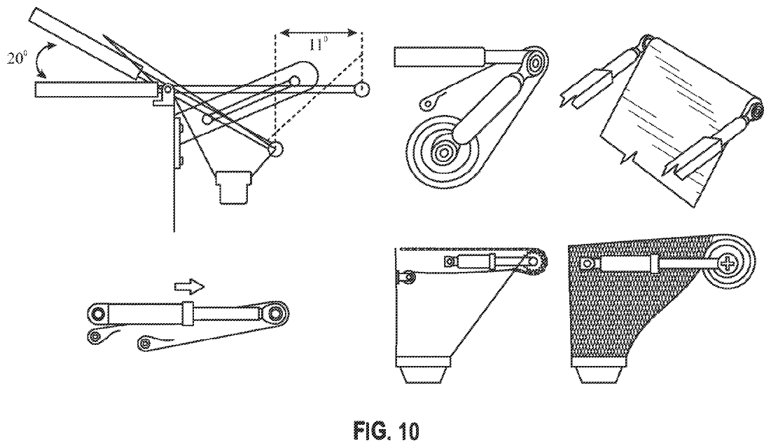

The first alternative embodiment makes use of a mechanism mounted to the robot which is semi-rigid and articulating in nature. The articulating nature of the mechanism facilitates the robotic operating states of moving down the row versus picking where the chassis is stationary. When the robot chassis is moving down the row, it is beneficial to have the fruit collection hoop mechanism retracted to the smallest possible form factor to avoid snagging on any obstacles or brushing against the crop. In the picking state it is desirable for the mechanism to be extended such that it reaches out under the gutter and crop to provide a surface for dropped fruits to land on. This articulation can be achieved by multiple hinged linkages, pivoting interleaved panels, or linear retraction/extension of a rigid front member as seen in FIGS. 8-10. Inherent to each of these concepts is the use of linear actuators which may be pneumatic cylinders, linear motor and rail systems, rotary motors with ball or lead screw mechanism, hydraulic pistons/diaphragms, or other similar linear motion systems. Double-acting cylinders allow the use of onboard compressed air to actuate the mechanism in either direction on command. Each of these designs incorporates a funneling shape to direct dropped fruits through an aperture at the bottom of the mechanism for collection and sensing/counting. The sides of these designs may be a combination of fabric, netting, or soft paneling to facilitate the appropriate handling of delicate fruits and vegetables. The leading edge(s) of all these designs are dynamic and allow for a variety of positions to be achieved, adding ˜10-20″ of coverage under the plants and gutter system while also accommodating physical obstacles in the environment.

### Second Alternative Fruit Collection Subsystem

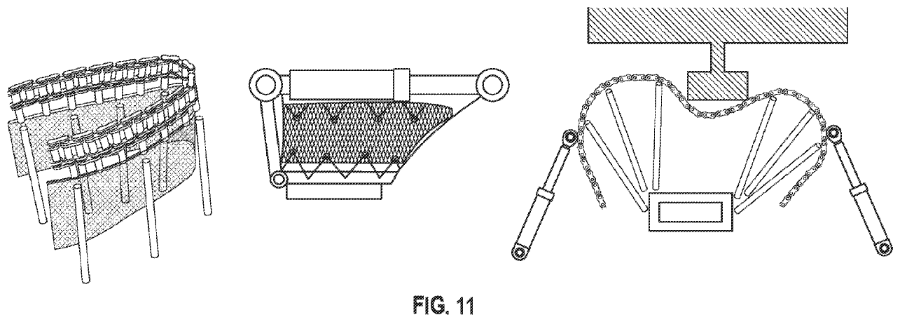

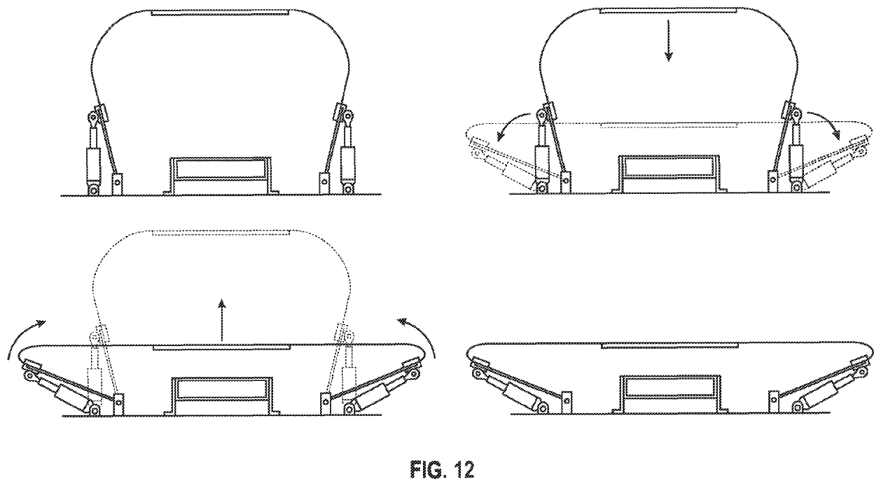

The second alternative embodiment makes use of a mechanism mounted to the robot which includes a dynamically adjustable and flexible hoop structure. The articulating hoop can be achieved by a flexible hinged plastic roller chain, or a thin flexible bar element as shown in FIGS. 11 and 12. The thin bar element can be made of plastic, spring steel, or a laminate of thin flexible materials. Inherent to both concepts like the first alternative embodiment is the use of pneumatic actuation by two double acting cylinders. Pneumatic cylinders allow the use of on-board compressed air to actuate the mechanism in either direction on command. The fixed end of the pneumatic cylinder is attached to the side of the robot and only has one degree of freedom, rotation. The other end of the pneumatic cylinder which is dynamic is attached via clevis pivot to the side of the hoop at prescribed points and has three degrees of freedom, translation in two directions as well as rotation about the clevis pivot. The body of the cylinders move in an arc motion while extending and retracting to make the flexible hoop change shape.

The hoop can change from an elongated ellipsoid in the retracted position into a more circular or rectangular profile on extension barring any physical obstructions in the way. The leading edge of these two designs are dynamic and allow for a variety of positions to be achieved, adding ˜10-20″ of coverage under the plants and gutter system while also accommodating physical obstacles in the environment. The final shape of the retracted and extended state can be further refined using short sections of semi-rigid plastic, fiberglass, or metal sections attached to the thin flexible hoop to keep the sides of the hoop more regular and straight in specific areas. In the case of a physical obstruction, the front portion of the hoop can conform to the obstacle taking on an irregular shape and allowing the hoop to flex around the obstruction and maintain additional catching volume compared to the rigid version. This flexible aspect also increases the design's natural durability compared to ramming a fully rigid linkage/bar up against an environmental obstruction.

Similar to the first alternative embodiment, these designs incorporate a funneling shape to direct dropped fruits through an aperture at the bottom of the mechanism for collection and sensing/counting. The side panels of these designs may include a mixture of compliant fabrics or netting such as a nylon-spandex weave or molded-rubber combined with less flexible fabric similar to ripstop nylon. Hook and loop fasteners or other releasable fasteners are integrated into the edges of the fabric/netting where it wraps around the hoop and attaches. Additionally, hook and loop fasteners or other releasable fasteners are incorporated where the softgoods attach down at the metal aperture/chute to allow for easy installation and removal of the hoop softgoods. Being able to quickly and repeatably install/remove the softgoods allows for laundering to mitigate risk of integrated pest management (IPM) concerns.

### Third Alternative Fruit Collection Subsystem

The third alternative embodiment makes use of a flexible fabric structure mounted to static points on the robot to act as a comprehensive landing zone for fruit dropped from the robotic grasper. This design would leverage the use of a mixture of compliant fabrics or netting combined with less flexible fabric similar to ripstop nylon as reinforcement. Additionally, quick attachment points are enabled by the use of ball and socket fasteners, with the ball stud feature mounted on the robot and the mating fastener being integrated into the fabric template. By leveraging the robot structure to integrate with, a large area below the arm can be covered to allow for the most flexibility in arm routing and fruit release planning with little concern of damaged fruit or missing a fruit being released by the arm after a successful pick.

### Fourth Alternative Fruit Collection Subsystem

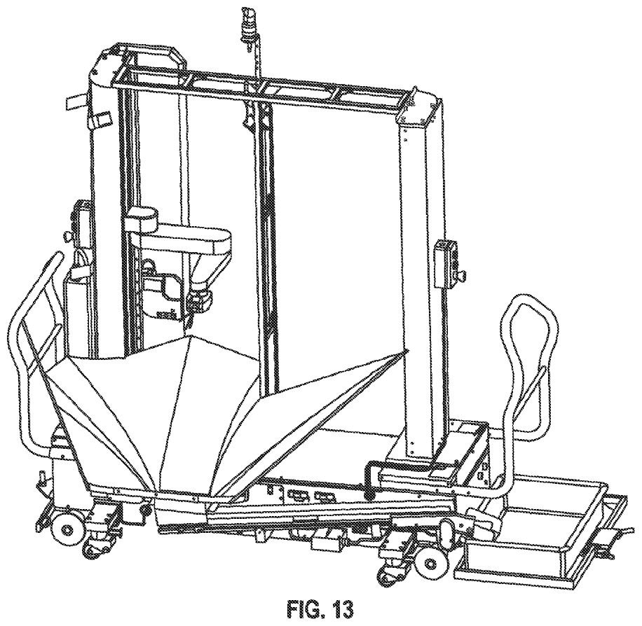

The fourth alternative embodiment makes use of a conveyance system along the side of the robot to allow fruits dropping through the sensing aperture in the hoops outlined above to be transported and deposited into a collection bin at the end of the robot. This has the advantage of significantly better human factors for access to the heavy fruit filled bins and adds better access to the robot through the top covers than prior designs that had a frame structure on top of the robot covers. An inclined conveyor allows for the optimal vertical space utilization by allowing the fruit collection system to be as low as possible to fit underneath gutters, vine bundles, and other obstructions while also having the deposit point high enough at the back of the robot to drop into a deep walled plastic bin. To enable this inclined arrangement, the conveyor belt may be cleated to increase friction, adding a physical barrier that prevents fruits from continually falling down the slope. Selection of the proper cleat height and spacing depends on fruit varietal and size, as well as proper timing based on conveyor speed. Getting the cleat spacing correct allows the system to convey individual fruit as much as possible for future implementation of sensing at the conveyor exit without over or under counting. Conveyor side walls and belt interface materials can be any number of plastic, metal, or elastomeric materials compliant with incidental food contact standards for produce harvesting. Both the third and fourth alternative embodiments are illustrated in FIG. 13.

### Fifth Alternative Fruit Collection Subsystem

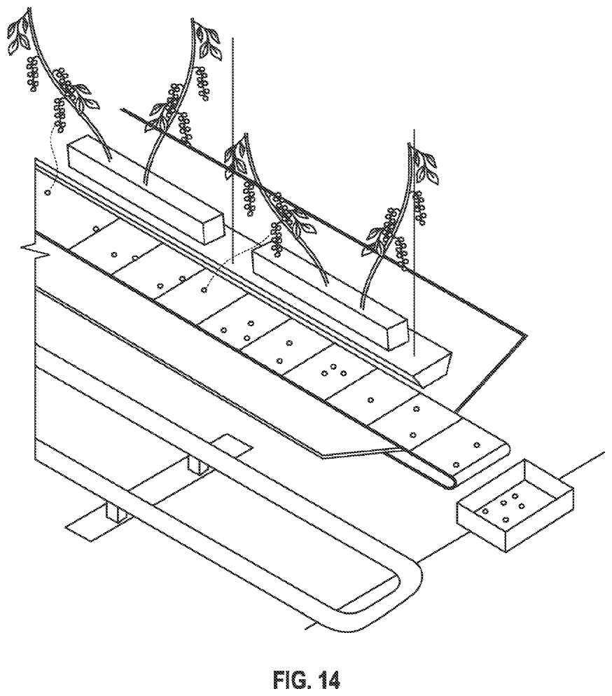

The fifth alternative embodiment involves a paradigm shift of the operational method of a greenhouse, where the robotic system would not require an on-board fruit collection system to successfully operate. In this embodiment, a large off-board fruit collection system would span the entire length of the crop row. This off-board fruit collection system would involve a large, draped netting/catch zone in the relative shape of a trough that would funnel fruits down to a central conveyance zone as shown in FIG. 14. This central conveyance zone would allow for the movement of all fruits towards the causeway to a centralized fruit processing zone where any loose plant matter could be filtered away from the fruits and vegetables themselves prior to being delivered to the packhouse.

### Harvest Module Autonomy Methods

The existence of a fruit collection system allowing for dynamic drop-off of fruits in motion enables other avenues to achieve performance improvements. Some embodiments may utilize a vision system coupled to a manipulator moving in the z-axis, where the vision system sees targets slightly above the pickable window of the arm. Picking in this paradigm operation moves from bottom to top to minimize the distances the picking arm must move between successive pick targets.

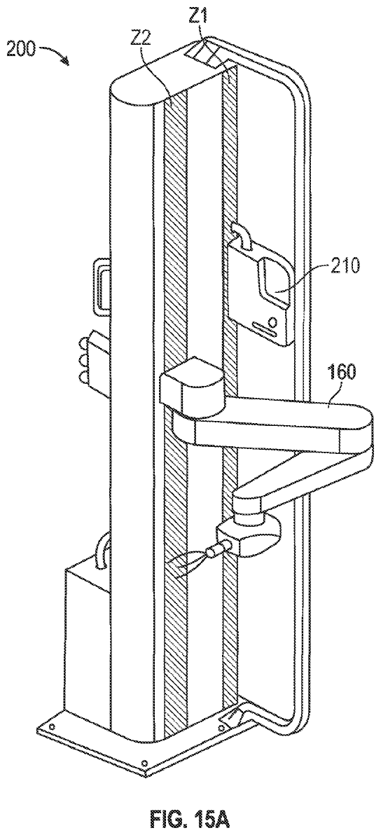

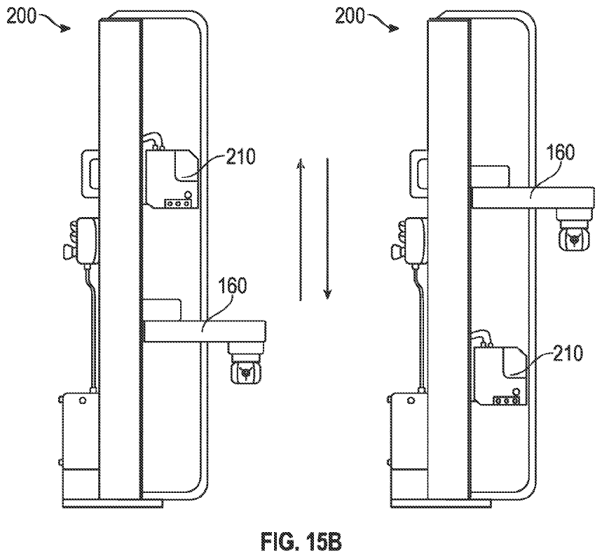

Aspects and embodiments of a robotic fruit harvesting system as disclosed herein may include a harvesting module in which the vision system is decoupled from the manipulator arm, allowing for independent target acquisition while the manipulator arm is executing a different pick sequence. Embodiments of such a harvesting module may include a manipulator arm with an associated gripper moving on one z-axis, and a vision system capable of moving on a second independent z-axis. One embodiment of a harvesting module 200 including a vision system 210 that may travel along a first z-axis track Z1 and that is decoupled from a manipulator arm 160 that may travel along a second z-axis track Z2 is illustrated in FIGS. 15A and 15B. The vision system 210 may operate in accordance with those described in PCT Patent Application Serial Nos. PCT/US2020/018285 or PCT/US2020/018395, the subject matter of which is incorporated herein by reference.

A decoupled perception and harvesting system together with a fruit collection tray enable tightly coupled operations for efficient harvesting. The embodiments disclosed herein are examples of the kinds of autonomous behaviors captured by the coordination of the three systems and the increasing complexity and interweaving of them. The building blocks of the autonomous system can be reorganized differently to achieve the highest throughput or work completion as possible. The building blocks used for autonomous harvesting operation include: fruit collection tray actuation, movement along greenhouse rails, identification of viable picking targets, route and task planning for picking operation, execution of picking, spatial reasoning of tomatoes or other fruit in 3D space, and collection & harvesting detection.

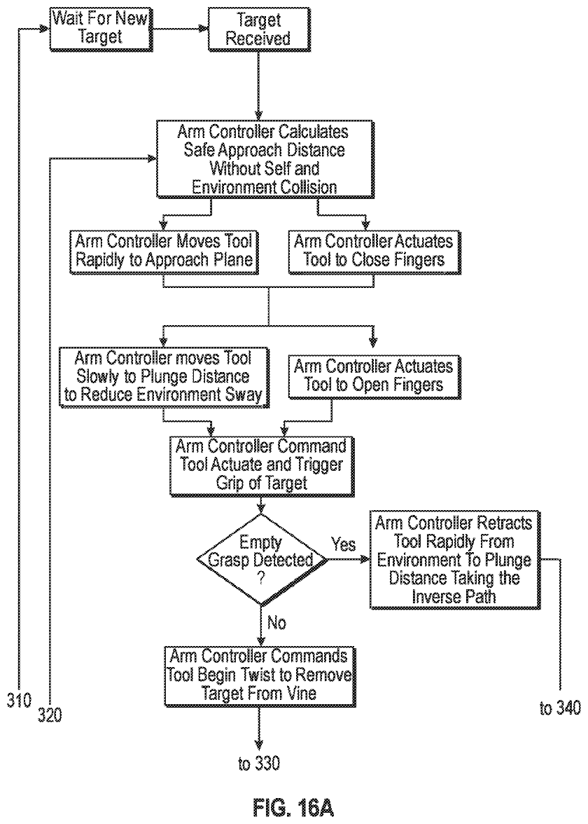

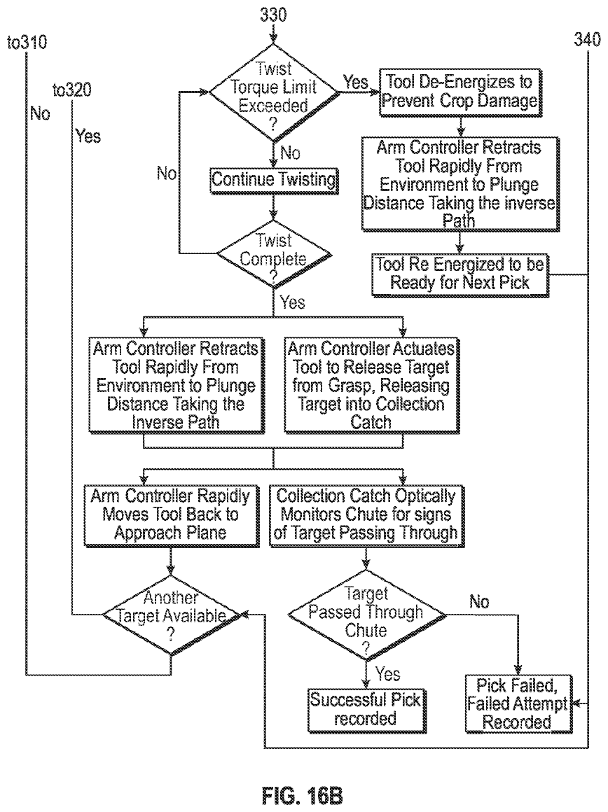

The picking motion of aspects and embodiments disclosed herein may take advantage of the expanded and actuated fruit collection tray, speeding up automated harvesting by nesting the fruit release and the retraction movement from the environment. One example of a picking flow diagram is illustrated in FIGS. 16A and 16B.

The first example of an autonomy process flow diagram with an independent motion axis for the picking and vision systems is shown in FIGS. 16A and 16B, where the primary direction of operation is always incrementing vertically up the column.

In this autonomous operation, the harvesting sequence is performed along a column of work while the vision and picking systems move higher with every successive image capture and picking operation. This way, less time is spent moving the perception and picking systems down the column, where the area filled with fruits has already been cleared of fruit.

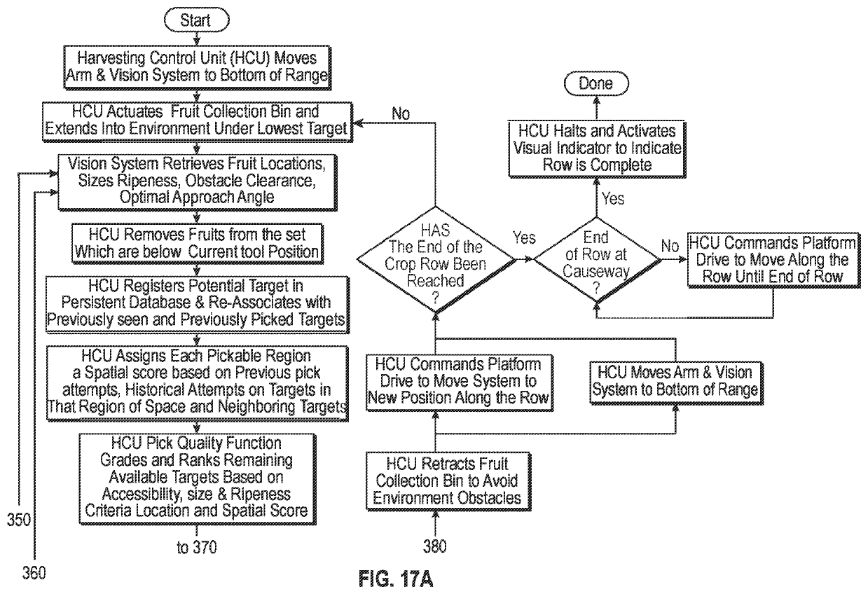

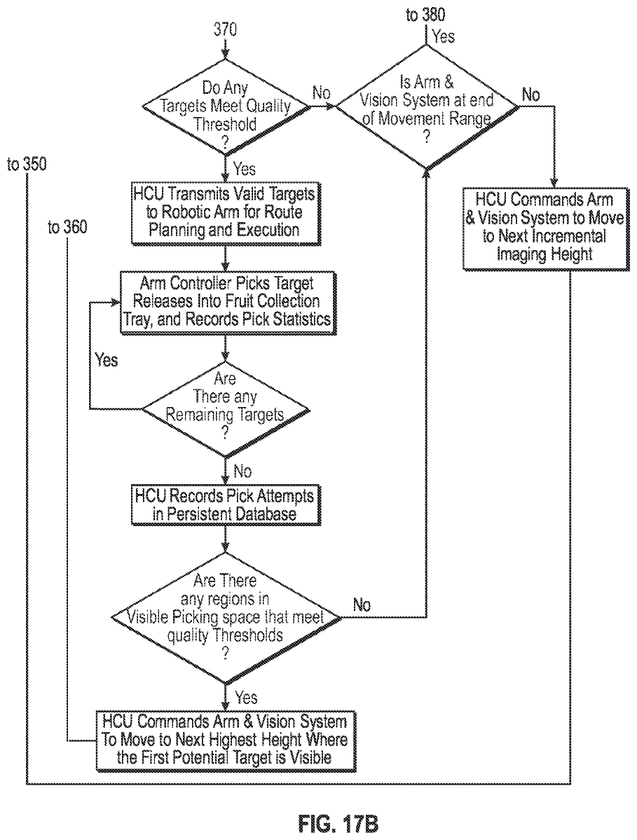

In a second example, illustrated in the flowchart of FIGS. 17A and 17B, an additional building block enabled by the independent-axis vision system is the idea of using the previous field of view to plan the next column of operation. This way the harvesting and imaging operations are not limited to moving only up in a column—the operations can be applied in either order depending on the forward-looking estimates of the scanned adjacent column.

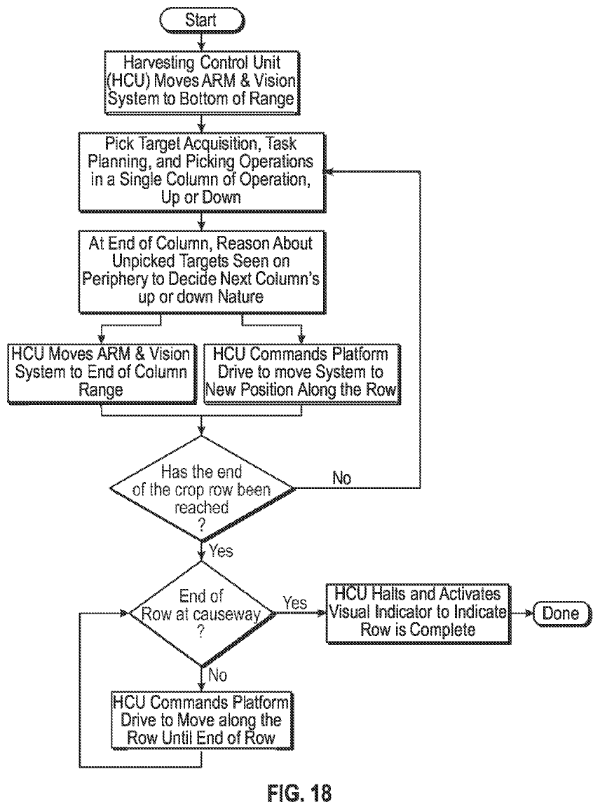

A third example of an autonomy flow with a decoupled vision system from the picking arm, illustrated in the flowchart of FIG. 18, expands on the nested process idea, allowing further nesting of the target acquisition and picking motions into an even faster autonomous harvesting robot. In this mode, the acquisition of targets happens simultaneously with picking of previously-acquired targets. In this mode of operation, the vision system is continuously feeding targets into a picking queue, continuously reasoning about the environment. Batches of future targets are added onto the queue, and targets are continuously harvested while the vision system is independently acquiring targets.

An additional embodiment of this idea includes the ability of the vision system to image many locations when planning the picking route to add to the picking queue, not just a single image.

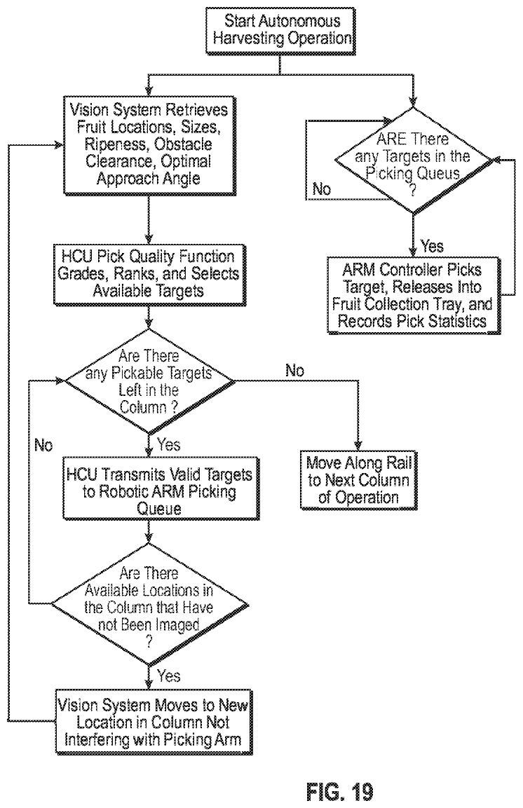

In a fourth example, illustrated in the flowchart of FIG. 19, the decoupled vision and picking arm enables in-the-picking-loop environment sensing that further increases the speed of autonomous harvesting. In this mode, the continuous picking queue on the harvesting arm is continuously added to, but after every picking operation, the vision system moves to a height at which the previously-picked region is re-imaged. This way, the vision system can re-confirm whether the fruit, for example, tomato, has been successfully harvested immediately after harvesting, taking this information into account when doing route and path planning.

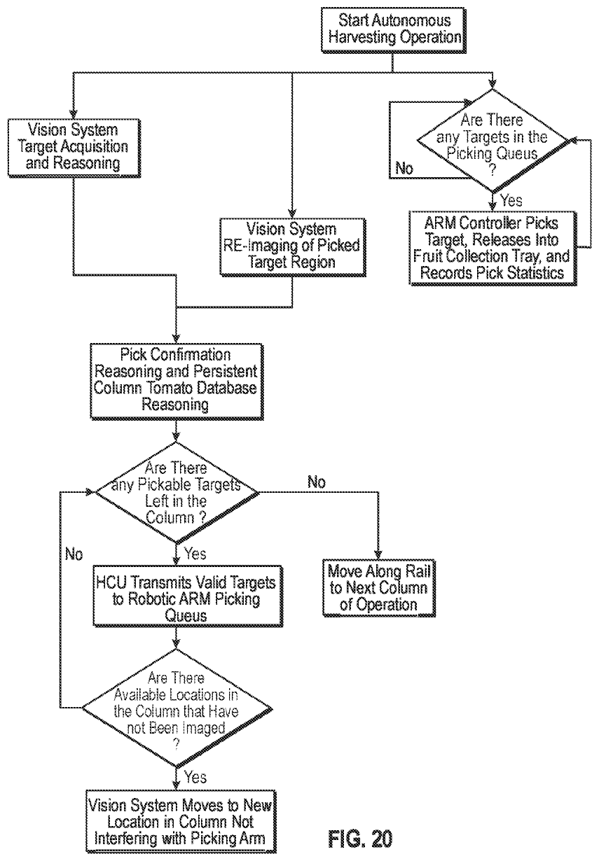

In a fifth example, illustrated in the flowchart of FIG. 20, the independent vision system can be used in pre-scan mode, combined with the intentional planning mode. Here, the continuous picking queue sent to the picking arm is kept at continuous queue size of a small number of targets, but the vision system spends all of the time moving continuously up and down along it's processing column, building a persistent model of all the fruit, for example, tomatoes in the entire row as the system travels along the rail. The harvesting control unit then continuously re-ranks the next available targets for picking while reasoning about all the targets remaining in the entire column.

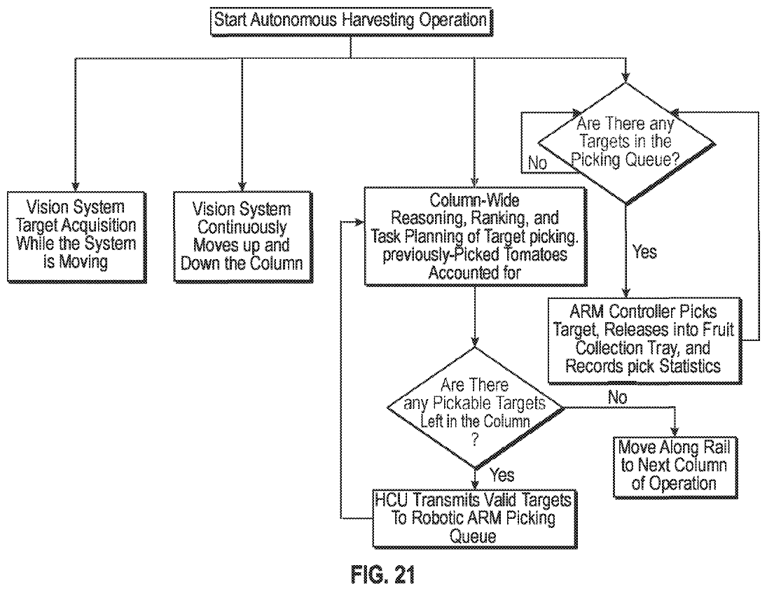

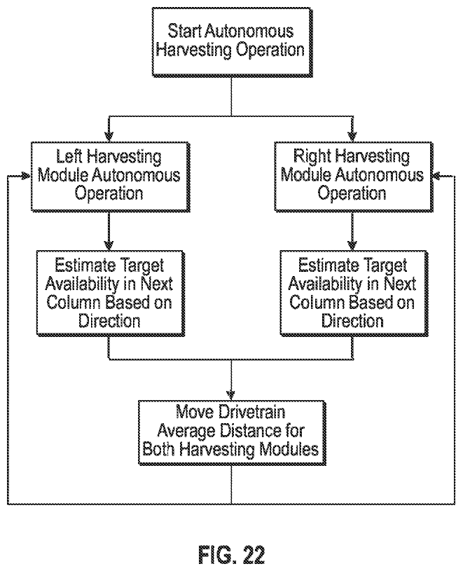

The addition of two harvesting modules on a single drive chassis further enables multiplicative factors in harvesting productivity. The two harvesting modules can harvest autonomously, but make unified decisions in tracking productivity, and in moving to new picking positions along the rails. To maintain modularity and maximal performance on the system as a whole, each harvesting module may be independently responsible for its own task and path planning as illustrated in the flowchart of FIG. 21. Each harvesting module sees different sides of a crop row and may not share information about specific targets or paths to pick. However, the shared decision to make is the movement of the drivetrain of the robot along the rails. The information used to reason about this decision is taken from both harvesting modules independently and reasoned about to make the optimal choice in terms of when to move the drivetrain along the rails and by how much, as illustrated the flowchart of FIG. 22.

In the dual-arm system configuration, any of the autonomy modes and components described above are embedded inside each of the left and right harvesting module autonomous modes. In this architecture, each module can be configured to use different autonomy modes to account for and adapt to different conditions and availabilities of crops.

### Dual Arm System Layouts

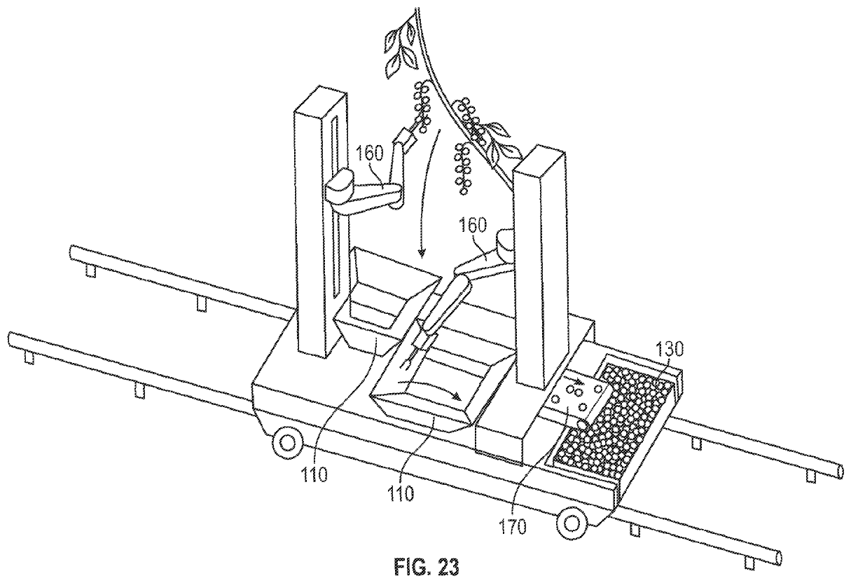

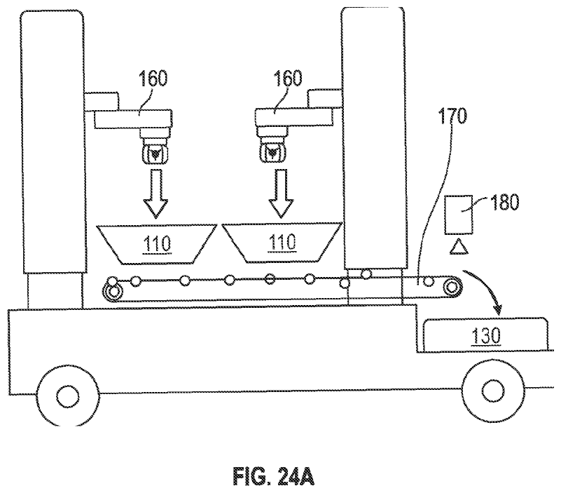

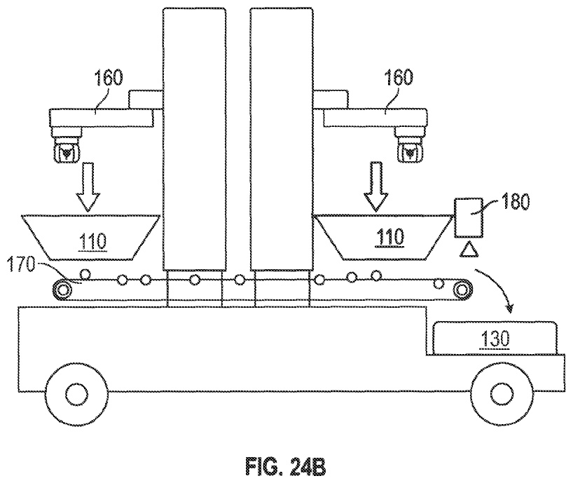

In the embodiments illustrated in FIGS. 23-24B the extensibility of the system architecture disclosed herein is shown. These embodiments embodiment duplicate the robotic manipulator 160 and fruit catch unit 110 to enable two modules to work in parallel while still relaying fruits to the same singular conveyor 170 for aggregation and assessment. The working principal of each individual manipulator 160 and lower fruit catch 110 is the same, but the concurrent operation of two such units ensures a multiplicative increase in overall system harvesting productivity.

It should be appreciated that multiple functional manipulator and catch units may be laid out in a variety of different arrangements to achieve the same underlying system operating method and advantages. An embodiment is illustrated in FIGS. 23 and 24A with manipulators 160 facing toward one another on opposite ends of the system platform versus facing away from each other from the center as illustrated in the embodiment of FIG. 24B, in each case with the lower fruit catches 110 collecting fruits below their area of operation. The concept is generally extensible to arrays of more than two such collection units and may be just as effectively employed with each unit harvesting from opposite sides of a single crop row versus two different regions of the same side of a crop row simultaneously.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While certain embodiments have been described, these embodiments have been presented by way of example only and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. A collection tool comprising:
a drive chassis;
a harvester module disposed on the drive chassis, the harvester module including:
a vision system configured to identify target objects; and
a robotic arm including a grasper configured to collect the target objects; and
a subsystem including an articulating semi-rigid catch member, the semi-rigid catch member configured to transition into a retracted state while the drive chassis is in motion and to transition into an extended state while the drive chassis is stationary and the robotic arm is in a process of collecting the target objects.

2. The collection tool of claim 1, wherein the semi-rigid catch member comprises a plurality of linkages.

3. The collection tool of claim 2, further comprising a linear actuator configured to articulate the plurality of linkages between the retracted and extended states.

4. The collection tool of claim 1, wherein the semi-rigid catch member comprises a plurality of pivoting panels.

5. The collection tool of claim 4, further comprising a linear actuator configured to articulate the plurality of pivoting panels between the retracted and extended states.

6. The collection tool of claim 1, wherein the semi-rigid catch member comprises a linear retracting and extending front member and a linear actuator configured to retract and extend the front member.

7. The collection tool of claim 3, wherein the linear actuator includes one or more pneumatic cylinders, linear motor and rail systems, rotary motors with ball or lead screw mechanisms, or hydraulic pistons/diaphragms.

8. The collection tool of claim 1, further comprising a target surface connected to the semi-rigid catch member and formed of a compliant material configured to receive collected target objects and to direct the target objects through an outlet.

9. The collection tool of claim 1, wherein the semi-rigid catch member comprises a dynamically adjustable and flexible hoop.

10. The collection tool of claim 9, wherein the hoop includes a flexible hinged roller chain.

11. The collection tool of claim 9, wherein the hoop includes a flexible bar element.

12. The collection tool of claim 10, further comprising a double-acting linear actuator configured to retract and extend the hoop.

13. The collection tool of claim 12, wherein the double-acting linear actuator is a pneumatic cylinder having one end affixed to a side of the collection tool and having a single rotational degree of freedom.

14. The collection tool of claim 13, wherein the pneumatic cylinder includes a second end affixed to a side of the hoop and having three degrees of freedom including translation in two directions as well as rotation about the clevis pivot.

15. The collection tool of claim 14, wherein a body of the pneumatic cylinder is configured to move in an arc motion while extending and retracting.

16. The collection tool of claim 9, wherein the hoop has a first area in a retracted position and a second area greater than the first area in an extended position.

17. The collection tool of claim 9, wherein a front portion of the hoop is configured to conform to an obstacle impacted by the hoop.

18. The collection tool of claim 9, further comprising a target surface formed of a compliant material connected to the hoop and configured to receive collected target objects and to direct the target objects through an outlet.

19-24. (canceled)

25. A collection tool comprising:
a drive chassis;
a harvester module disposed on the drive chassis, the harvester module including:
a vision system configured to identify target objects; and
a robotic arm including a grasper configured to collect the target objects; and
a comprehensive landing zone for target objects dropped from the grasper including a flexible fabric structure mounted to static points on the collection tool.

26-32. (canceled)

33. A system for collecting agricultural products from a crop row comprising:
a collection tool including:
a drive chassis;
a harvester module disposed on the drive chassis, the harvester module including:
a vision system configured to identify target objects; and
a robotic arm including a grasper configured to collect the target objects; and
a catch system including:
a trough-shaped catch zone extending substantially along a full length of the crop row formed of a compliant material and including an outlet; and
a conveyance zone disposed below the outlet of the catch zone and including a conveyor configured to transport target objects to a collection bin.
